(19) United States
(12) Patent Application Publication
(10) Pub. No.: US 2013/0033025 A1
(43) Pub. Date: Feb. 7, 2013

(54) SAFETY DEVICE FOR A MOTOR VEHICLE

(71) Applicant: Ulrich RICK, Braunweiler (DE)

(72) Inventor: Ulrich RICK, Braunweiler (DE)

(73) Assignee: GM GLOBAL TECHNOLOGY OPERATIONS LLC, Detroit, MI (US)

(21) Appl. No.: 13/562,860

(22) Filed: Jul. 31, 2012

(30) Foreign Application Priority Data
Aug. 5, 2011 (DE) 10 2011 109 607.1

(51) Int. Cl. B60R 21/231; B23P 11/00

(52) U.S. Cl. 280/743.1; 29/428

(57) ABSTRACT

A safety device for a motor vehicle and a method for producing such a safety device are provided. The safety device comprises an expansion body with an elastic diaphragm that delimits a hollow space. A filling fluid source is configured for filling the hollow space subject to elastic expansion of the diaphragm.

### CROSS-REFERENCE TO RELATED APPLICATION

This application claims priority to German Patent Application No. 10 2011 109 607.1, filed Aug. 5, 2011, which is incorporated herein by reference in its entirety.

### TECHNICAL FIELD

The technical field relates to a motor vehicle safety device with an expansion body and a filling fluid source for filling a hollow space of the expansion body and a method for its production.

### BACKGROUND

From DE 10 2005 052 532 B3 and EP 0 895 903 A1 a motor vehicle safety device with an expansion body having an elastic diaphragm, which delimits a hollow space, a filling fluid source for filling the hollow space subject to elastic expansion of the diaphragm is known in each case. Both publications propose a single-chambered expansion body with only one hollow space. This limits the geometry of the filled expansion body that can be realized with justifiable expenditure to simple geometrical basic bodies.

It is at least one object herein to provide an improved generic safety device for a motor vehicle.

### SUMMARY

In accordance with an exemplary embodiment, a motor vehicle safety device, in particular for a vehicle occupant of a passenger car, comprises one or a plurality of expansion bodies with an elastic diaphragm that delimits a hollow space entirely or partially, and a filling fluid source for filling the hollow space subject to elastic expansion of the diaphragm.

A diaphragm as contemplated herein means a body whose wall thickness relative to its surface is small in an elastic, non-deformed state. In an exemplary embodiment, the diaphragm is a body wherein the quotient of wall thickness divided by the surface is a maximum of 0.05%, for example a maximum of 0.01%, as is the case for example with a rectangular plate with 10 cm edge length and 1 mm wall thickness (1/(100×100)=0.01%).

An elastic diaphragm in an exemplary embodiment means a diaphragm that can be greatly deformed elastically, such as, a diaphragm the elongation of which at break in the tensile test according to DIN 53504, amounts to at least 100%, for example, at least 500% and/or the modulus of elasticity at room temperature amounts to a maximum of 0.5 GPa, such as a maximum of 0.1 GPa.

In an embodiment, an elastic diaphragm comprises one or a plurality of elastomers. An elastomer can in particular be natural or synthetic rubber, silicone or a thermoplastic elastomer (TPA).

The elastic diaphragm is fluid-tight with respect to a filling fluid, in accordance with one embodiment. However, when an adequately large filling fluid flow is available, a diaphragm can also have a certain fluid permeability.

The diaphragm can be embodied in single or multiple layers. Reinforcement elements such as for example bands, areal elements or nets, for example, from textile material, can be locally arranged on the diaphragm. The reinforcement elements have a greater modulus of elasticity and therefore expand less during a filling. In an embodiment, the reinforcement elements are materially connected partially to a complete side with the inside and/or outside of the diaphragm, for example glued, welded, laminated-in or vulcanized-on. The elastic diaphragm then expands during filling in a substantially tied-up manner through reinforcement elements connected with it in places and functioning as catching bands or besides the reinforcement elements completely connected to it, so that these influence the shape and expansion characteristic of the filled diaphragm.

The filling fluid source is equipped for filling a hollow space of an expansion body with a filling fluid, such as with a gas, for example with air. The filling fluid source can in particular comprise a pyrotechnical and/or pressure gas generator. The filling fluid source can supply a hollow space of an expansion body; it can additionally supply also a further inflatable airbag. In addition or alternatively, two or more filling fluid sources for filling the same hollow space can be provided.

In another embodiment, a filling fluid source comprises a micro gas generator (MGG). A filling fluid source can then be arranged in the same component as the expansion body, for example, formed as constructional unit with the expansion body and be arranged directly on or even in a hollow space of the expansion body.

In a further embodiment, the filling fluid source is connected to a control device of the safety device that is equipped in order to fill the hollow space of the expansion body on the basis of an activation signal, which, for example, is transmitted to the control device by a spacing, delay, deformation and/or force sensors. For this purpose, the control device can comprise a computation unit for processing the activation signal, a valve device in order to fluidically connect the filling fluid source to the hollow space, and/or an ignition device for the pyrotechnical liberation of filling fluid.

According to an embodiment, an expansion body comprises a hollow space and a further hollow space. Because of this, it becomes advantageously possible, on the one hand, to optimize individual hollow spaces geometrically with respect to their production and/or filling. On the other hand, by combining two or more Tillable hollow spaces a desired outer contour, in particular enveloping the expansion body can be realized in a design filling state.

Design filling state here is the description of a state in which the expansion body is filled with the filling fluid under reference conditions, for example, at a reference temperature of about −10° C., 0° C., 10° C., 20° C. or other standard temperatures for the operation of the motor vehicle, with a reference filling pressure, and with a reference filling fluid quantity at a reference maximum elongation of about 100%, 250% or 500% or the like. In such a design filling state, the expansion body assumes a predetermined outer contour, which is predetermined through the shape of the elastic diaphragm and, in an embodiment, through reinforcement elements.

In another embodiment, two or more, for example, all hollow spaces of an expansion body in the design filling state have different volumes and/or outer contours. Equally, two or more, for example, all hollow spaces of an expansion body in the design filling state can have the same volumes and/or outer contours. Exemplary outer contours include, but are not limited to, geometrical basic bodies such as polyhedrons, such as cuboids, cylinders, cones, ellipsoids, for examples, spheres, pyramids, or the like. By combining a plurality of same and/or different volumes and/or outer contours, expansion bodies with most diverse envelopes can thus be realized through hollow spaces that are simple to produce and/or to fill.

In technical terms, envelope is the term used to describe a surface that is smooth, for example, steadily curved, which with minimum area size encloses all hollow spaces. For illustration, an envelope can be imagined for example as a rubber skin stretched over the outer contours of the hollow spaces. The envelope can be purely virtual and thus describe the total outer contour of the hollow spaces mathematically. Thus, a cylindrical hollow space, which on the outside is surrounded by further cylindrical hollow spaces of a lesser height, for example has a cone-shaped virtual envelope.

Equally, in a further embodiment, a folded, textile and/or elastic envelope is provided that envelopes two or more, for example, all hollow spaces jointly entirely or partially and thus smoothes possible edges of the individual hollow spaces. In addition or alternatively, the expansion body can comprise an envelope that completely or partially encloses an elastic diaphragm. This envelope, too, can be folded, textile, and/or elastic, diaphragm material.

In an embodiment, two or more, for example, all hollow spaces in the design filling state have different filling pressures. Through different filling pressures, locally different elasticities and dampings can be realized. Pressureless or hollow spaces can also be provided, in which only ambient pressure is present. Equally, two or more, for example, all hollow spaces of the expansion body can have the same filling pressures in the design filling state, which can facilitate the design and/or filling.

In another embodiment, the filling pressure of a hollow space in the design filling state is influenced on the one hand through a control device for setting the filling behavior. In addition or alternatively, the filling pressure of a hollow space in the design filling state is influenced through a device for emptying, for example, one or a plurality of controllable outward ventilation openings.

One such device for setting the filling and/or emptying behavior can comprise a valve, choke or the like, that is arranged between the hollow space and the filling fluid source or a filling fluid sink, of the surroundings. In an embodiment, a fluid passage between two or more hollow spaces is provided to fill the hollow spaces through the same filling fluid source(s) in this way or to empty these into the filling fluid sink. This fluid passage can be variable through the control device, for example, in that a valve—at least partially—is opened or closed. In another embodiment, the control device is equipped for setting different filling and/or emptying behaviors of two or more hollow spaces.

In an embodiment, the further hollow space or hollow spaces are each entirely or partially delimited by a further elastic diaphragm. The diaphragms, which delimit different hollow spaces, can be interconnected. In a further embodiment, two or more, for example, all diaphragms, each of which delimits a hollow space, are releasably or materially interconnected so that a continuous expansion body with a plurality of hollow spaces is obtained. To this end, the diaphragms can be individually produced and subsequently interconnected through buttoning, clamping, gluing, welding, vulcanizing or the like. Equally, diaphragms which delimit different hollow spaces can also be produced integrally with one another, wherein this entire diaphragm can then be thought to be divisible into the different diaphragms delimiting the individual hollow spaces.

In another embodiment, one or a plurality of hollow spaces jointly enclose at least one recess that is open on one or both sides at least partially, which can be closed by a covering. The covering is directly connected to the diaphragm, for example, materially connected, such as through gluing, welding, vulcanizing or the like, or indirectly, such as via bands or the like.

For example, a ring or donut-shaped hollow space completely encloses a recess that is open on both sides, a hollow space with a cross section in the shape of an eight completely closes recesses that are open on both sides, a cuboid with a blind hole-like pocket completely closes a recess that is open on one side, or a C-ring-shaped hollow space, i.e. with a circular cross section and a gap in circumferential direction, closes a recess partially. As contemplated herein, a hollow space encloses a recess at least partially when the circumference of the recess delimited by the hollow space delimits at least 75%, for example, at least 85% of its total circumference. Thus, a ring of a circle segment, which extends for example over an angular range of 315%, i.e. has a gap of 45%, encloses for example 87.5% of the recess located inside (315°/360°=87.5%). Such gaps in the circumference, i.e. an only partial enclosure is possible when the face ends of the hollow space delimiting the gap(s) are tied to one another through the covering and/or holding means, for example, one or a plurality of bands, ropes or the like. This prevents an excessive enlargement of the recess subject to the moving apart of the hollow space face ends. In an embodiment, the hollow space or hollow spaces enclose the recess completely or over its entire circumference. For example, four hollow spaces connected to one another at their ends into a circular ring, each of which has a quarter of a circular segment-shaped cross section, jointly enclose the recess in the middle of the circular ring.

In another embodiment, a covering closes off the recess. To this end, the covering can be designed closed or continuous, and can be of the same material as the elastic diaphragm and/or of a textile material. Equally, the covering can also have a through-opening and be designed in the manner of a net or grid, in turn from textile and/or diaphragm material. A textile net or grid-like covering is to mean a covering of stranded threads.

If the covering comprises diaphragm material, it can elastically expand during the filling of the hollow space in order to cover the enlargement recess. If the covering is at least partially of textile and thus less elastic material than the diaphragm, it can, in an embodiment, unfold during filling and so adapt to the enlarging recess.

Upon catching of a part of a body, such as a head, of a vehicle occupant, the covering can yield by a predetermined dimension, for example, subject to further elongation of an elastic covering, further elastic deformation of the diaphragm delimiting the hollow space, on which the covering is fastened, elastic deformation of holding bands, which connect the diaphragm and the covering, and/or reduction of the recess, for example of its diameter.

Through the covering of a recess enclosed by one or a plurality of hollow spaces, an expansion body can be made available, which on the one hand requires only a smaller filling volume compared with a hollow space without recess, which can be well realized through the elastic diaphragm and on the other hand, offers a large catching area with the covering at the same time.

Advantageously, the outer contour or envelope, which is defined by a plurality of hollow spaces, can center a part of a body of a vehicle occupant to be caught, such as the head of such an occupant, towards the recess that is enclosed by the hollow spaces. In addition or alternatively, the hollow space can center a part of a body of a vehicle occupant to be caught, such as the head of such an occupant, bead-like towards the recess that is enclosed by the hollow space. To this end, the recess can have an at least substantially round or oval first cross section in an embodiment, which corresponds at least substantially to an outer contour of the part of the body to be caught or is slightly larger relative to that. In a plane that is perpendicular thereto, the recess can at least substantially have a mushroom-shaped cylindrical or cone-shaped cross section.

According to an embodiment, one or a plurality of hollow spaces in each case is partially delimited by a material that opens out upon being filled. In this regard, the enlargement of the hollow space is thus realized during the filling by combining the elastic expansion of the diaphragm and the unfolding of a material that is less elastic compared with the former. Because of this, the shape and expansion characteristic can be influenced, while larger filling volumes can also be realized relative to expansion bodies the hollow spaces of which become larger only through expansion of an elastic diaphragm.

Fabric here is to mean a single or multi-ply fabric, such as it is known for example from conventional unfolding airbags. In particular, the material can be materially connected to the elastic diaphragm, preferentially glued, welded or vulcanized-on.

In another embodiment, an inward ventilation and/or outward ventilation opening is arranged in the material. In this manner, the load that occurs on the circumference of such an opening can be introduced into the expansion body by way of the material that is better suited for this purpose.

According to a further embodiment, the elastic diaphragm is releasably fastened to a carrier that co-delimits the hollow space. According to another embodiment, it is fastened to the carrier through forming or casting of the carrier and/or materially fastened to the carrier through vulcanizing, gluing and/or welding.

The carrier can form a flange of a gas generator of the filling fluid source, an expansion body housing, in which the unfilled expansion body and also the gas generator are arranged, or form an expansion body covering that is intended in order to be folded away from the expanding expansion body and/or destroyed. Equally, the carrier can be an element of the vehicle structure of the vehicle body and, for example, of a roof frame of the vehicle, an element of the vehicle interior covering such as, for example, of an instrument panel, of a steering wheel, of a door or pillar covering, of a roof headlining, or of an element of a vehicle seat. The carrier can also form a part of one of the aforementioned components, for example, the bottom of an expansion body housing or of a brace of the vehicle body. In an embodiment, the carrier serves for fixing the expanding expansion body to the vehicle, and it can additionally predetermine locally the shape of the expansion body in the filled state by the fastening contour.

The carrier can be designed frame-like for this purpose. Equally, the carrier can also be designed as a flat or curved plate. In another embodiment, an inward ventilation and/or an outward ventilation opening is/are arranged in the carrier. In this manner, the load that occurs on the circumference of such an opening can be absorbed by the carrier that is better suited for this purpose.

With its region adjoining the fastening contour, the carrier locally defines the hollow space or hollow spaces together with the elastic diaphragm. To this end, the carrier is produced from a plastic, in particular thermoplastic and/or a metal and embodied filling fluid-tight. If an adequately large filling fluid flow is available, the carrier can also have a certain fluid permeability.

In a further embodiment, the diaphragm is fastened to the carrier through a clamping connection, such as, through screwing or flanging. The diaphragm can be releasably fastened to the carrier in particular through screwing. This can make possible a simple assembly and a replacement of a damaged or used diaphragm. In order to be able to achieve an adequately fluid-tight fastening between diaphragm and carrier, screws can be arranged so tightly next to one another in an embodiment, that the local pressure points of the diaphragm caused by these merge with one another, i.e. the diaphragm is pressed against the carrier alongside the entire fastening contour, thus being held on the carrier through frictional connection. In addition or alternatively, a support element, for example in the form of individual washers or of a frame-like flange having bores for a plurality of screws, can be arranged on the surface of the diaphragm facing away from the carrier, which introduces the normal force applied by the screws into the diaphragm over a larger surface area.

For example, the diaphragm can be fastened to the carrier through seaming of the carrier. To this end, the carrier can be suitably formed plastically, which means by flanging, tumbling, caulking and the like. Seaming of the carrier means forming a spacing between two continuous surfaces of the carrier located opposite each other, in which an edge of the diaphragm is held in a clamped and/or materially joined connection. Here, the diaphragm can be initially placed on one of the surfaces and the carrier subsequently deformed plastically. Equally, the carrier can initially be suitably formed or cast with the spacing of plastic and the edge of the diaphragm subsequently introduced into the space, wherein the edge in an embodiment in the un-deformed state has a greater wall thickness than the spacing, is introduced in the spacing subject to elastic deformation where it only partially relaxes, so that it is clamped through frictional connection between the surfaces of the carrier. In addition or alternatively, the diaphragm can also be materially connected to one or both surfaces of the carrier, in particular, glued.

In an embodiment, the diaphragm can be fastened to the carrier in that an edge of one of the diaphragm and the carrier is fastened in a groove of the other one of the carrier and the diaphragm. To this end, the groove can be initially produced and then the edge cast in it. Equally, the edge can be produced initially and during the casting of the other one of carrier and the diaphragm, enclosed by the other one, so that the groove is formed. In particular, the diaphragm can be insert-molded at its edge with the plastic forming the carrier. In an embodiment, a groove or edge can have a narrower web region that merges into a region that is wider compared to this, which through positive connection counteracts a pulling-out of the edge from the groove.

Additionally or alternatively, the diaphragm can be fastened to the carrier in that one or a plurality of protrusions of one of the diaphragm and the carrier is fastened in the other one of the carrier and the diaphragm. Here, the protrusions and the recesses can be initially produced and then the protrusions introduced in the recesses subject to elastic deformation of protrusion and/or recess. Equally, it is possible to cast the recesses about the protrusions or conversely cast the protrusions in the recesses. A protrusion can have a narrower region, which merges into a region that is wider compared to this, which through positive connection counteracts a pulling-out of the protrusion from the recess. Additionally or alternatively, edge and groove or recesses and protrusions can be fastened to each other through frictional and/or materially joined connection, in particular glued together.

In an embodiment, the diaphragm is fastened to the carrier through vulcanizing. This can be combined with one of the aforementioned positive fastenings. Equally, the diaphragm can also be vulcanized onto the carrier and thus adhere to the carrier without a separate adhesive being required for this purpose.

In another embodiment, a cavity comprises an outward ventilation opening. Through its size and/or arrangement, a desired characteristic, for example, filling kinematic, stiffness and/or damping of the expansion body can be predetermined.

### BRIEF DESCRIPTION OF THE DRAWINGS

The various embodiments will hereinafter be described in conjunction with the following drawing figures, wherein like numerals denote like elements, and wherein:

FIG. 1 is a steering wheel with a safety device in a cross section along the line I-I in FIG. 2 according to an embodiment; and

FIG. 2 is the safety device of FIG. 1 in a top view.

### DETAILED DESCRIPTION

The following detailed description is merely exemplary in nature and is not intended to limit the various embodiments or the application and uses thereof. Furthermore, there is no intention to be bound by any theory presented in the preceding background or the following detailed description.

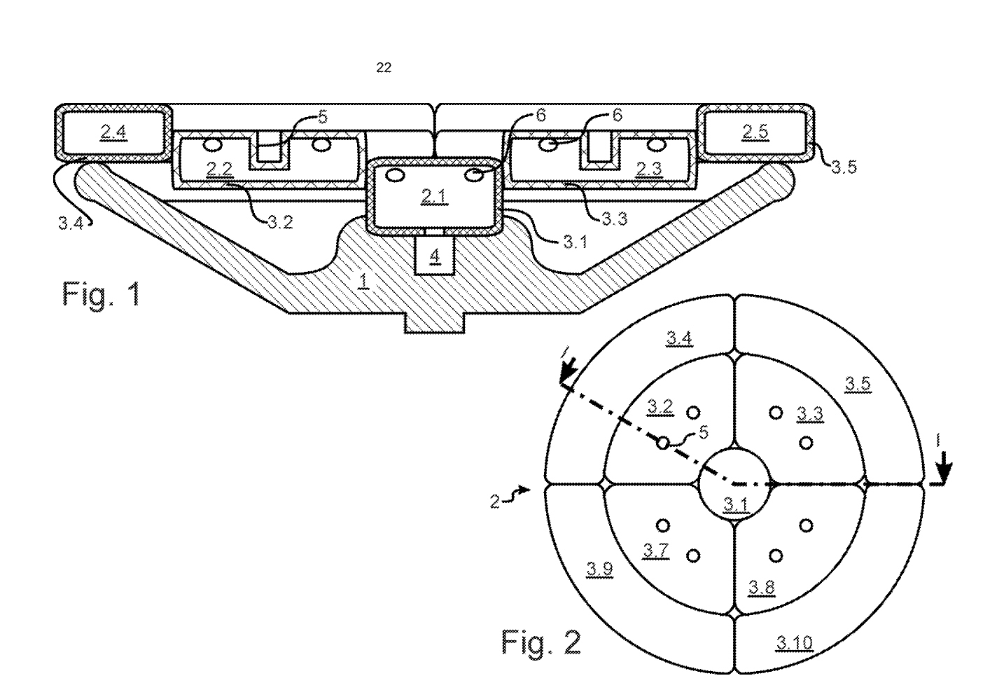

FIG. 1 shows in a cross section along the line I-I in FIG. 2 a vehicle steering wheel 1 with a safety device according to an embodiment. The safety device comprises a filling fluid source in the form of a schematically indicated microgas generator 4 and an expansion body, which in FIG. 1, 2 is shown in the filled, expanded design filling state.

The expansion body comprises, in the exemplary embodiment, a central hollow space 2.1 connected with the steering wheel pot of the steering wheel 1, which is delimited by an elastic diaphragm 3.1 from natural or synthetic rubber. As is evident by viewing FIG. 1, 2 together, the hollow space 2.1 has a cylindrical shape in the design filling state.

The expansion body comprises four quarters of circular segment-shaped additional hollow spaces, of which in FIG. 1 two hollow spaces 2.2, 2.3 are visible. These four additional hollow spaces are each delimited by further elastic diaphragms 3.2, 3.3, 3.7 and 3.8 of natural or synthetic rubber, which are materially connected to the diaphragm 3.1 of the hollow space 2.1 through vulcanizing or integrally formed through joint casting. Each of these hollow spaces encloses two blind hole-like recesses 5. Because of this, the damping behavior of the expansion body can be varied.

Located outside, the expansion body comprises four additional quarters of circular segment-shaped hollow spaces, of which in FIG. 1 two hollow spaces 2.4, 2.5 can be seen. These four further hollow spaces are each delimited by further elastic diaphragms 3.4, 3.5, 3.9 and 3.10 of natural or synthetic rubber, which are materially connected to the diaphragms 3.2, 3.3, 3.7 and 3.8 through vulcanizing or integrally formed through joint casting.

The middle additional hollow spaces delimited by the diaphragms 3.2, 3.3, 3.7 and 3.8 on the one hand communicate with the hollow space 2.1 via filling fluid passages 6 and on the other hand with the further hollow spaces located outside, which are delimited by the diaphragms 3.4, 3.5, 3.9 and 3.10, so that the microgas generator 4 fills all hollow spaces of the expansion body with filling fluid. Because of this, the expansion body expands from an elastically un-deformed or even compressed original state into the design filling state shown in FIG. 1, 2.

In the design filling state, the hollow spaces jointly enclose a recess with cone-shaped cross section, which centers the head of a driver towards the recess in the event on impact.

In a modification which is not shown, a plurality of hollow spaces, in particular, all hollow spaces can be surrounded by an envelope. In addition or alternatively, a covering can close off the recess jointly formed by the hollow spaces, thus presenting a flat impact surface.

In the original state, the expansion body can be concealed behind a covering in the steering wheel pot, which it opens upon expansion (not shown).

Through chokes in the filling fluid passages 6 and/or outward ventilation openings (not shown), different filling pressures can be set in the different hollow spaces. As is evident from FIG. 1, 2, the hollow space 2.1, the middle hollow spaces 2.2, 2.3 and the hollow spaces 2.4, 2.5 located outside have different outer contours and volumes. Because of this, a stiffness and damping of the expansion body can be locally predetermined.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A safety device for a motor vehicle, the safety device comprising:
an expansion body with an elastic diaphragm that delimits a hollow space; and
a filling fluid source is configured for filling the hollow space subject to elastic expansion of the elastic diaphragm.

2. The safety device according to claim 1, wherein the expansion body comprises two hollow spaces that are in a design filling state and that have different or same volumes, outer contours and/or filling pressures.

3. The safety device according to claim 1, wherein the expansion body comprises two hollow spaces and the safety device further comprises a control device configured for setting different filling and/or emptying behaviors of the two hollow spaces.

4. The safety device according to claim 1, further comprising a variable, fluid passage between two hollow spaces.

5. The safety device according to claim 1, wherein the elastic diaphragm is connected through a materially joined connection to a further elastic diaphragm, which delimits a further hollow space.

6. The safety device according to claim 1, wherein the hollow space at least partially encloses a recess that is open on one or both sides.

7. The safety device according to claim 1, wherein the hollow space is closed off by a covering.

8. The safety device according to claim 1, wherein the hollow space is partially delimited by a material that opens out upon filling.

9. The safety device according to claim 1, further comprising a carrier that delimits the hollow space and to which the elastic diaphragm is fastened.

10. The safety device according to claim 9, wherein the elastic diaphragm is releasably fastened to the carrier through forming or casting of the carrier and/or of the elastic diaphragm.

11. The safety device according to claim 9, wherein the elastic diaphragm is materially connected to the carrier through vulcanizing.

12. The safety device according to claim 9, wherein the carrier is a generator flange, an expansion body housing, an expansion body covering, a vehicle structure element, vehicle interior covering element, vehicle seat element, or a part thereof.

13. The safety device according to claim 1, wherein the expansion body comprises an envelope that at least partially encloses the elastic diaphragm.

14. A method for producing a safety device comprising:
an expansion body with an elastic diaphragm that delimits a hollow space and comprising a further hollow space; and
a filling fluid source is configured for filling the hollow space subject to elastic expansion of the elastic diaphragm, the method comprising:
connecting the elastic diaphragm to a further elastic diaphragm, which delimits the further hollow space, through a materially joined connection or integrally with each other.
